(19) United States
(12) Patent Application Publication
(10) Pub. No.: US 2016/0210682 A1
(43) Pub. Date: Jul. 21, 2016

(54) Method And Apparatus For Enhanced In-Store Retail Experience Using Location Awareness

(71) Applicant: 24/7 Customer, Inc., Campbell, CA (US)

(72) Inventors: Pallipuram V. KANNAN, Saratoga, CA (US); Bhupinder SINGH, Bangalore (IN)

(21) Appl. No.: 15/047,559

(22) Filed: Feb. 18, 2016

Related U.S. Application Data
(63) Continuation-in-part of application No. 13/868,945, filed on Apr. 23, 2013, now abandoned.
(60) Provisional application No. 61/644,341, filed on May 8, 2012.

(51) Int. Cl. G06Q 30/06; H04W 4/02

(52) U.S. Cl. CPC G06Q 30/0631; G06Q 30/0601; G06Q 30/0633; G06Q 30/0635; H04W 4/023

(57) ABSTRACT

Embodiments of the invention provide a nexus between a user's presence within or proximate to a brick and mortar store outside of an explicit user transaction within the store, that is based solely upon the user's presence within the store, and not on any affirmative actions taken by the user by maintaining location awareness of the user and by communicating this awareness in real time, as the user moves from location to location, to brick and mortar stores at or near to the user's location. In this way, embodiments of the invention link the user's virtual presence, for example via the Internet, and all of the user-related information that is available for data mining, for example using big data techniques, to the user's physical presence at a physical location to create an enhanced user experience within the physical location in real time.

### CROSS REFERENCE TO RELATED APPLICATIONS

This application is a continuation-in-part of U.S. patent application Ser. No. 13/868,945, filed Apr. 23, 2013, which application claims priority to U.S. provisional patent application Ser. No. 61/644,341, filed May 8, 2012, each of which is incorporated herein in its entirety by this reference thereto.

### BACKGROUND OF THE INVENTION

1. Technical Field

The invention relates to the customer experience. More particularly, the invention relates to a method and apparatus that uses location awareness to provide an enhanced in-store retail experience for customers.

2. Description Of The Background Art

In information technology, big data is a collection of data sets so large and complex that it becomes difficult to process using on-hand database management tools or traditional data processing applications. The challenges include capture, curation, storage, search, sharing, analysis, and visualization. The trend to larger data sets is due to the additional information derivable from analysis of a single large set of related data, as compared to separate smaller sets with the same total amount of data, allowing correlations to be found to spot business trends, determine quality of research, prevent diseases, link legal citations, combat crime, and determine real-time roadway traffic conditions.

While on-line commerce is now well established, and big data is beginning to become an important factor in personalizing user experiences across a range of on-line activities, the brick and mortar world remains unaware of all user information except for, perhaps during the execution of sales transactions, when stored user profiles linked to the user's identity may be used for authentication and, perhaps, to offer point of sales incentives.

A promising new technology that is finding increasing use in the brick and mortar world is near field communication (NFC), which is a set of standards for smartphones and similar devices to establish radio communication with each other by touching them together or bringing them into close proximity, usually no more than a few centimeters. Present and anticipated applications include contactless transactions, data exchange, and simplified setup of more complex communications, such as Wi-Fi. Communication is also possible between an NFC device and an unpowered NFC chip, called a tag. Thus, a user can enter a brick and mortar store and make a purchase without presenting a credit card, for example using NFC features of a cell phone. Because the transaction is entirely electronic, much can be learned about the user at the time of the transaction from what is already known about the user. Even so, given the insights about the user that could be offered, for example, by mining user information using the big data tools mentioned above, such transactions typically concern no more than authenticating the user and completing a sale.

### SUMMARY OF THE INVENTION

Embodiments of the invention provide a nexus between a user's presence within, in proximity to, or movement toward a brick and mortar store outside of an explicit user transaction within the store, that is based solely upon the user's presence within the store, and not on any affirmative actions taken by the user. A presently preferred embodiment, with user permission as required, maintains location awareness of the user, for example via geo-location of a device within the user's possession, such as a smart phone, and communicates this awareness to the herein disclosed system in real time, as the user moves from location to location, which in turn communicates this information to brick and mortar stores and other such physical establishments at or near to the user's location. In this way, embodiments of the invention link the user's virtual presence, for example via the Internet, and all of the user-related information that is available for data mining, for example using big data techniques, to the user's physical presence at a physical location to create an enhanced user experience within the physical location in real time.

### BRIEF DESCRIPTION OF THE DRAWINGS

FIGS. 1 and 1A are block schematic diagrams that show the use of location awareness to provide an enhanced in-store retail experience for customers according to the invention;

FIG. 2 is a block schematic diagram showing a user profile as applied to the use of location awareness to provide an enhanced in-store retail experience for customers according to the invention;

FIG. 3 is a flow diagram showing the use of location awareness to provide an enhanced in-store retail experience for customers according to the invention;

FIG. 4 is a block schematic diagram that illustrates the data flow used to determine an individual's proximity to a retail store location according to the invention; and

FIG. 5 is a block schematic diagram that depicts a machine in the exemplary form of a computer system within which a set of instructions for causing the machine to perform any of the herein disclosed methodologies may be executed.

### DETAILED DESCRIPTION OF THE INVENTION

Embodiments of the invention provide a nexus between a user's presence within, in proximity to, or movement toward a brick and mortar store outside of an explicit user transaction within the store, that is based upon the user's presence within the store, and at times may also be based on an affirmative action taken by the user in conjunction with users location.

A presently preferred embodiment, with user permission as required, maintains location awareness of the user, for example via geo-location of a device within the user's possession, such as a smart phone, and communicates this awareness to the herein disclosed system in real time, as the user moves from location to location, which in turn communicates this information to brick and mortar stores and other such physical establishments at or near to the user's location. For example, the customer's smart phone, which may be enabled with GPS, may transmit the GPS location of the device to a central server that houses facility data, user interaction, transaction, or behavior data in physical stores, user interaction, transaction, or behavior for online interactions, chat, IVR, and any other such channel of transaction. This information stored on the central server may subsequently be processed and passed to computing devices in store, or in possession of, or in use by the customer. These computing devices may be any one or more of kiosks, desktops, cell phones, tablets, mobile GPS devices, RFID tags, etc. attached to the product, cart, store shelves, etc.

In this way, embodiments of the invention link the user's virtual presence, for example via the Internet, and all of the user-related information that is available for data mining, for example using big data techniques. The data stored on the central server may include, but is not limited to, user location data, user transaction data, interaction data, etc. on any one or more interaction channels such as, IVR, chat, online/web, etc., facility related information such as, product locations, checkout locations, product inventory, ordering information, etc. The data stored on the central server can be stored on a big data platform for example, Hadoop, Vertica, etc. and may be processed using statistical and machine learning techniques to draw business insights that can be used for improving the customer experience and/or revenue for business, or any other such business outcome. The machine learning and statistical techniques include one or more of supervised and unsupervised modeling techniques, such as, linear regression, logistic regression, Naïve Bayes, decision trees, random forests, support vector machines, kmeans, hierarchical clustering, association mining, time series modeling techniques, Markovian approaches, text mining models, stochastic modeling techniques, etc. User location data includes, identification of presence, proximity, location or velocity of customer in absolute terms or relative to a facility or physical object, e.g. store, product, shelf, vehicle, physical structure, etc.

For example, consider the use case of modeling likelihood to purchase in-store versus online, where user-related information includes but is not limited to web pages browsed, operating system, time of site, time spent on individual pages, number of product pages browsed, etc., and these variables are linked with variables that are based on the user's physical location to calculate proximity to nearest store, and are further used as a combined set of variables to model the likelihood to purchase in-store versus online. The data for several consumers can run into several gigabytes, and machine learning techniques such as, logistic regression, support vector machines, decision trees, random forests, Naïve Bayes, etc. may be applied to build the model, and subsequently, execute the model.

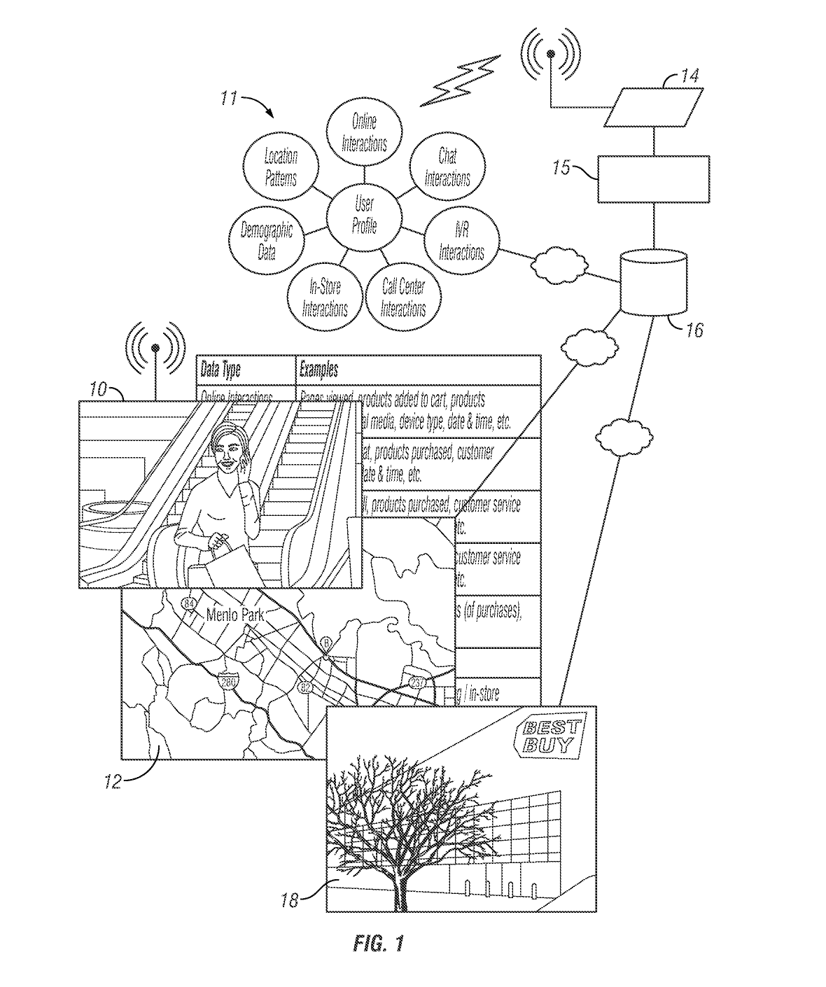

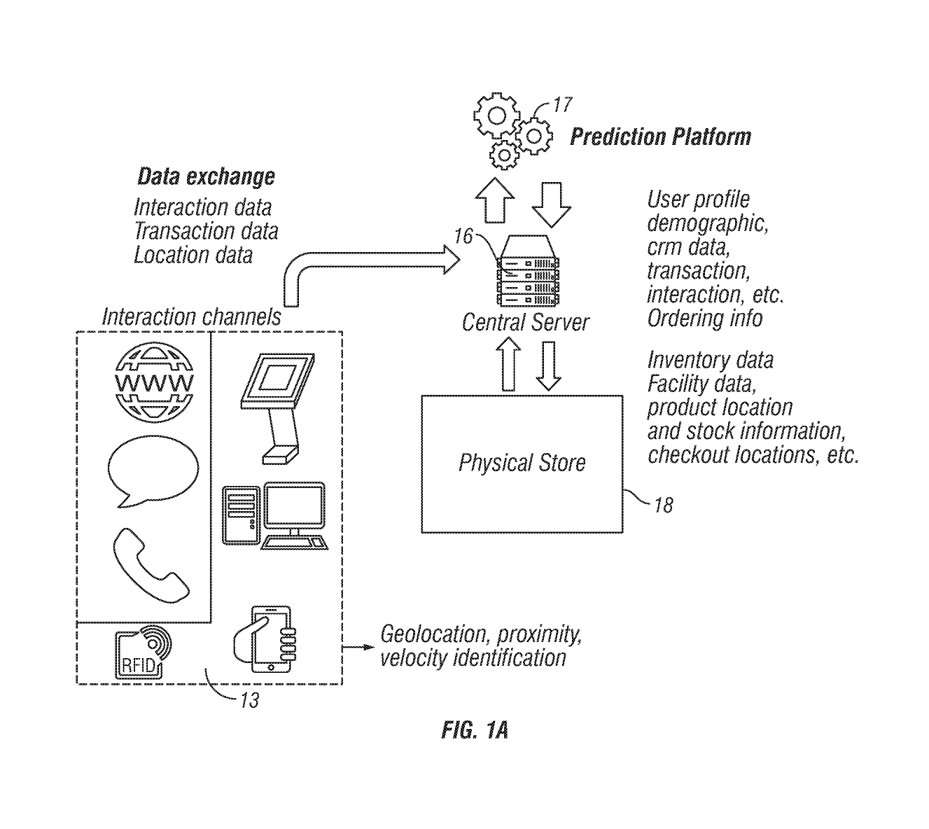

FIGS. 1 and 1A are block schematic diagrams showing a user 10 in a store, for example, a mall or department store. While the invention is described herein in connection with a presently preferred embodiment that relates to retail sales locations, those skilled in the art will appreciate that the invention is readily applicable to other physical locations which may include, for example and not by way of limitation, service offices, such as insurance or medical facilities, entertainment venues, such as gyms and movie theaters, vehicles, airports, banks, etc.

The user has a wireless device, such as a smartphone, but which could be any wireless device that can be passively interrogated or that passively identifies the user's location, such as a GPS, GPRS, EDGE, 3G, 4G, LTE, NFC device, RFID device, Bluetooth device, etc. The location of the user may also be derived from a wired or wireless computing device accessible to the customer such as, a kiosk, a desktop, a laptop, or any other such device which identify and further transmit location information to the central server.

An on-line profile 11 is associated with the user, which contains information about the user's Web browsing habits, demographic information, Web journeys at one or more websites, and the like. A user profile is a set of personal data associated with a specific user. A profile refers therefore to the explicit digital representation of a person's identity. A user profile can also be considered as the computer representation of a user model. A profile can be used to store the description of the characteristics of a person.

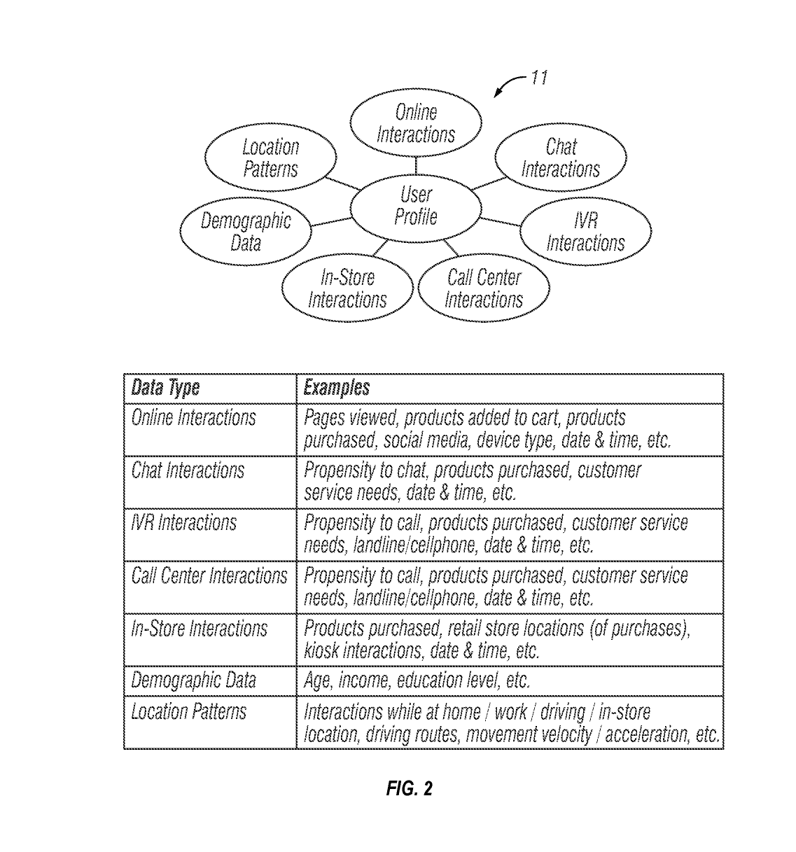

This information, aggregated from user interactions, transactions across one or more channels 13, integration with CRM data, any other third-party data and stored in a central database 16, can be exploited by systems taking into account the persons' characteristics and preferences. For example, one can identify the recency and frequency of purchases online and at the store from the recorded history of previous transactions of the user. Similarly, one can identify the demographics of the customer by integrating with the CRM data. If the customer has interacted over chat or IVR within the past few days, his likely intent for visiting the store may also be known. Based on pages browsed or the previous interaction history, embodiments of the invention can also discover the degree of interest in discounts and offers. Profiling is the process that refers to construction of a profile via the extraction from a set of data. User profiles can be found on operating systems, computer programs, recommender systems, or dynamic websites (such as online social networking sites or bulletin boards). An example of a user profile is shown in FIG. 2.

Through a big data platform, which comprises large scale distributed computing frameworks capable of processing several gigabytes in batches or real-time such as, one based on Hadoop, Vertica, Spark, etc., data pertaining to an individual's interactions across channels, e.g. websites, call centers, in-store, can be stitched together to provide a holistic view of that individual's preferences and behavior patterns. Certain data elements can be used to link interaction data across channels, for example the individual's telephone number, email address, etc. The data elements can be linked deterministically or through probabilistic means, to create a profile based on data logged across one or more channels of interaction. An example of linking data deterministically comprises collecting customer ID on a log in page from the user in an authenticated web journey, collecting more information regarding the authenticated customer intent on a online chat channel, and further linking it to intents over an IVR channel, wherein the customer ID and the phone number can be used to link the data logged across three channels. In another instance, data available from third parties such as, social data from Facebook or any other such social networking site, may be used to link

Although the user is not actively using the wireless device as part of the shopping experience, the device is active and, as such, the location of the device is known through use of geolocation techniques. Geolocation is the identification of the real-world geographic location of an object, such as mobile phone, or an Internet-connected computer terminal. Geolocation may refer to the practice of assessing the location, or to the actual assessed location. Geolocation is closely related to the use of positioning systems, but can be distinguished from it by a greater emphasis on determining a meaningful location, e.g. a street address, rather than just a set of geographic coordinates.

In addition to the physical location, other attributes, such as direction of motion, velocity, acceleration, etc. are also considered part of the geolocation and can be used in connection with a prediction platform 17 to customize an in-store retail experience. For example, the user may be offered personalized discount offer messages on his smart phone through SMS or a native app, based on items located in the vicinity of the customer. Alternately, personalized ads can be screened in-store depending on the users buying behavior, and best discount offers on items located in the vicinity of the customer.

Such ad impressions may further be optimized based on the aggregated purchase behavior of groups of customers that are within zones from where the ads may be visible. The proximity of customers to a segment of products may be calculated based on the location of a wireless device held by the customer or a wired or wireless device being accessed by the customer, and calculating the distance of one or more location sensing devices attached to products, store shelves, store locations, or any such stationary or moving points for which the location is known.

In FIG. 1, the user's location 12 is identified. For either geolocating or positioning, the locating engine often uses radio frequency (RF) location methods, for example Time Difference Of Arrival (TDOA) for precision. TDOA systems often use mapping displays or other geographic information systems. This is in contrast to earlier radiolocation technologies, for example Direction Finding where a line of bearing to a transmitter is achieved as part of the process. Internet and computer geolocation can be performed by associating a geographic location with the Internet Protocol (IP) address, MAC address, RFID, hardware embedded article/production number, embedded software number, such as UUID, Exif/IPTC/XMP or modern steganography, invoice, Wi-Fi positioning system, or device GPS coordinates, or other, perhaps self-disclosed information.

Geolocation usually works by automatically looking up an IP address on a WHOIS service and retrieving the registrant's physical address. IP address location data can include information such as country, region, city, postal/zip code, latitude, longitude and time zone. With mobile devices, the geolocation can be determined from the GPS coordinates, WiFi coordinates, and/or cell tower triangulation of the device itself. This geolocation information, along with the device ID, such as a UUID, is available to applications running on the mobile device. These applications can transmit the geolocation and device ID over the data network to a big data platform. Backend servers can then compare the geolocation information from the mobile device against retail store location coordinates to determine proximity to the store and whether the device is moving toward, within or away from the store location.

In embodiments of the invention, the user's geolocation is used to determine the user's proximity to one or more stores or other physical establishments 18. An embodiment of the invention receives user presence information as an input 14 from any one of wireless handled device, smart phone, kiosk, desktop, laptop, or any other wireless or wired device that can sense location information and further transmit it to a central server 16. Further, the location information may also be inferred based on known position information of a device and any other attribute such as IP address of a device being accessed. This information is combined at a processor 15, such as a computer or other data processing element, with the user's geolocation, profile, and other information within or available to, e.g. via the Internet, a database 16, to identify stores and other establishments that are near to the user's location or at which the user is located. For example, one may identify the location of a person based on the IP address of the device being accessed by customer or GPS information. Based on the location information of facilities either received from other GPS devices attached to the facility or positional information stored in a database, proximity to facilities can be calculated by taking a simple arithmetic computation of known positional coordinates, or based on looking up information in a database, for example, looking up all facilities in Orlando, Fla.

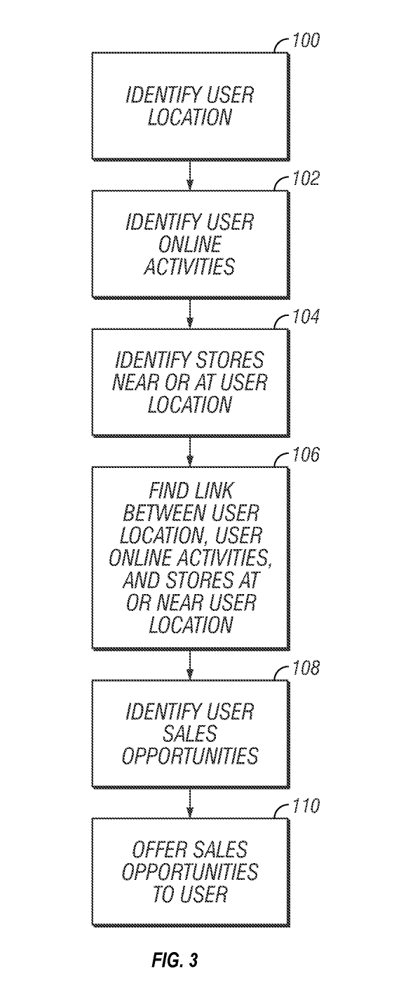

FIG. 3 is a flow diagram showing the use of location awareness to provide an enhanced in-store retail experience for customers according to the invention. An enhanced in-store experience may be encompasses but is not limited to, offering a personalized shopping experience, simplifying location of products of interest, making recommendations for products of interest, offering discounts on products of interest, offering proactive help to customers with issues, cancellations, returns, etc. The user's location is identified (100) and online activities and/or other profile information related to the user is then identified (102).

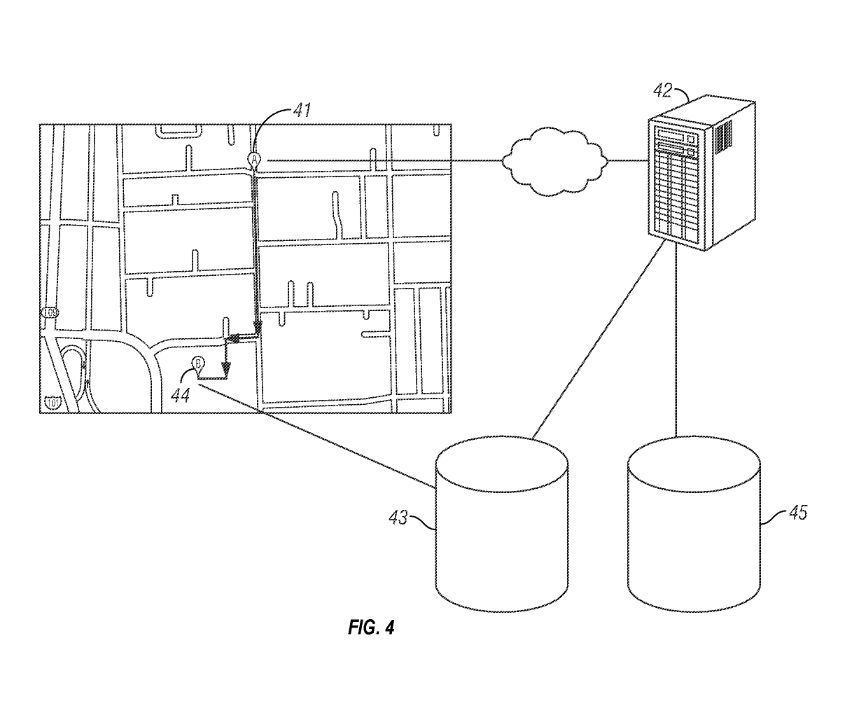

FIG. 4 is a block schematic diagram that illustrates the data flow used to determine an individual's proximity to a retail store location according to the invention. An application on the mobile device transmits geolocation information 41 to an application server 42. This geolocation information can include the GPS coordinates of the mobile device, along with the direction of movement and velocity which can be obtained from the device's built-in accelerometer. The application server then uses a backend database 43 to look up nearby retail store locations 44. Using the device ID, the application server identifies the corresponding user profile in the big data platform 45 and retrieves relevant interaction data associated with the individual across all interaction channels as, products of interest, frequency and recency of purchases, online visits and store visits, CRM data, demographic data, etc. The user's location information is then used to identify stores or other physical establishments at or near the user's location (104). These locations may be part of a commerce network that subscribes to a service which is provided in accordance with the invention, they may be provided based upon a user subscription to a service based upon the invention, or they may be provided without a preexisting commitment on the part of either a merchant or the user.

A nexus between the user location, the user's online or other activities, and stores at or near the user's location is found (106). As an example, assume a user has been browsing online for toys, and his physical location is close to a toy store. The customer can be offered deals for toys proactively through SMS, a native mobile app, or any other such interaction channel. The customer may also be showcased an advertisement for toys on a digital hoarding within the visibility of his current location.

Based upon this nexus, sales, or other opportunities for the user are identified (108) and offered to the user (110). One could build a purchase propensity model using various variables such as, demographic information, current and/or historic travel pattern, online web behavior, e.g. pages visited, time on site, time on page, text searches, etc. Such a purchase propensity model can be built using statistical and machine learning algorithms such as, Naïve Bayes, decision trees, random forests, support vector machines, and the like. Cross-sell models may also be built using market basket analysis to identify other products and services that may be offered to the customer.

If a customer has recently inquired about an item previously out of stock, the customer may be notified if he is in vicinity of the store if the product is now available. Offers can be presented to the user via a number of mechanisms including, but not limited to, mobile device application alerts, SMS, email, and a phone call using an outbound dialer, ads showcased to customers over digital hoardings, personalized ads through native applications on cell phones, or SMS. For example, for an authenticated airline customer on a native mobile application, CRM data shows that he has a flight in the next hour, but is currently located three hours away from the source airport. In this instance, he can get a personalized prompt or proactive inbound call for a deal against cancellations and adjusted bookings to the next flight.

An aspect of the invention is similar to, but significantly distinct from the use of geotargeting in geomarketing and Internet marketing, which is a method of determining the geolocation of a website visitor and delivering different content to that visitor based on the visitor's location, such as country, region/state, city, metro code/zip code, organization, IP address, ISP, or other criteria. A common usage of geotargeting is found in online advertising, as well as Internet television with sites, such as iPlayer and Hulu which may restrict content to those geolocated in specific countries. In contrast thereto, an embodiment of the invention tries to find a connection between the user's present location and the user's online activities, especially in connection with online commerce, as well as interactions across other channels including IVRs, call centers, and online chat platforms, and then identifies stores or other establishments at or near to the user's location that have a linking connection with the user.

The link between the user activity across several channels may be made deterministically or probabilistically. For example, in authenticated journeys, a user may enter his details such as, a unique identifier of a customer, phone number, email address, or any such Personally Identifying Information (PII) information, that is stored, as it is filled in by customers on a webpage, as key-value pairs in cookies, browser cache, etc. If the same user, accesses any other channel of communication, and authenticates with the same or related information, a link can be established between the channels. For example, if a user is associated with a customer ID and email address on the web, and authenticates with the same customer ID and a phone number on the IVR, a link can be established between the interaction history on the web, and the IVR.

One may also use a finger printing technique, wherein a combination of several types of non-PII information of the customer may be stored and then used to identify customers. For example, storing a combination of user agent, OS, OS version, font personalization, browser plugin details, mobile apps installed, etc. and using the combination of such data to fingerprint or identify customers across one or more channels. For probabilistic linking, one may use statistical or machine learning algorithms to predict likely unique identifier or PII information of a customer, based on other data logged such as, data logged on one or more channels, third-party data, social data, etc.

The statistical or machine learning technique could be any one or more of, and not limited to, Naïve Bayes, Bayesian networks, logistic regression, support vector machines, decision trees, random forests, etc. For example, if the user was recently shopping for tires online, but did not make a purchase, then the user may be presented with an opportunity, for example by a text message, to purchase tires when the user is visiting a store that has a tire department, such as Wal-Mart or Costco, or a sales person in the store may be alerted of the customer's presence and approach the customer with a special sales offer. The linking connection here is the fact that the customer is interested in tires, which is known from the online browsing history, and is in proximity of a store that stocks tires.

A key aspect of the invention is the fact that the user was not specifically looking for tires at this store, for example the user may have been buying groceries, but the user location information and online activities provided a basis for identifying the opportunity to offer tires to the user. The proximity of the customer to the product of interest may be calculated based on the distance between the geolocation and the location of the products available from the store database or through geolocation of the product available from a device attached to the product or the shelf/storage space in the store. When the customer distance is within certain minimum distance from the product, the customer may be presented with a special deal on the cellphone native app. This can be done using recommendation systems which uses collaborative filtering or user based filtering.

This action is entirely passive and takes place in real time while the user is moving from location to location. Thus, unlike geotargeting, which takes place while the user is actively browsing the Internet from a fixed location, the invention makes use of the coincidence between the user's presence at a location and a connection between the location and the user's past online behavior. It is important to note that, in many cases, the invention may require user permission due to concerns regarding user privacy. Internet privacy involves the right or mandate of personal privacy concerning the storing, repurposing, providing to third-parties, and displaying of information pertaining to oneself via the Internet. Privacy can entail either PII or non-PII information, such as a site visitor's behavior on a website. PII refers to any information that can be used to identify an individual. For example, age and physical address alone could identify who an individual is without explicitly disclosing their name, as these two factors are unique enough to typically identify a specific person. Thus, because at least some user information is required, it is thought that the protection of user privacy may require user assent before some embodiments of the invention may implemented in connection with any specific user.

Use cases of the herein disclosed invention include, but are not limited to:

Embodiments link previous user interactions with a business, such as previous purchase history, products viewed online but not purchased, products purchased, social media posts, etc., and current location awareness to notify and/or alert a user, e.g. via mobile device application alerts, SMS, email, or a phone call, of the location of products of interest, e.g. products that the user previously searched for online but did not purchase, when the user's location coincides with the store location.

Embodiments link online and/or phone purchases and current location awareness to offer related and/or complementary products proactively when the user enters a store for in-store pickup of online purchases. For example, if a person purchased laptop online, he could be offered a deal on hard-disks, once he entered the store for in-store pickup, based on knowledge of the last product he purchased, and association mining or market basket analysis of top products being purchased together with the retailer.

Embodiments link previous customer service requests, e.g. warrantee inquiry, and current location awareness to offer related and/or complementary products proactively when a user drives near a retail store. For example, if a customer has inquired about the warrantee of a previously purchased item, and walks into a store to pickup a laptop recently purchased, he can be offered an exclusive deal for an extended three-year warrantee for the laptop.

For cross-sell scenarios, embodiments automatically determine relevant items not currently available in the store and proactively offer a purchase option and optimal delivery channel to the user based on the user's preferences. For example, if a user enquired about iPhone 5 which was not in stock, by using association mining of online browsing behavior, embodiments can identify other product pages frequently visited by customers who viewed iPhone 5 page, order history, the products corresponding to the top pages associated with iPhone 5 in terms of support, confidence or lift may be recommended for a cross-sell opportunity for the relevant items. The offer can be delivered at checkout or after checkout, e.g. given the velocity of movement of the mobile device, determine the user is walking to his car in the parking lot and send an offer before he starts the car and drives away.

Embodiments link previous user interactions and/or online and/or phone purchases and current location awareness to notify and/or alert the user proactively when inventory is available in a nearby store. For example, by integrating with the store inventory data, and CRM data of the customer, one can notify customers with recently unfulfilled sales attempts regarding the products inquired about, if the store inventory showed positive stock numbers for customers that were within ten miles from the store and had enquired about an out-of-stock product in the last 30 days.

Embodiments scan QR and/or UPC codes using the individual's mobile device, not a computer or system associated with the retail establishment, in the store to get product information and comparisons, and to purchase online with a mobile device, where the product is delivered via a preferred method, e.g. in-store pickup at a current or alternate store or shipped to an address on file. In this case, the user takes a picture of the QR/UPC code using a mobile device. Based on the geolocation of the device, it is proactively known which store the user is in, and the system can provide relevant product information, e.g. that the location does not have inventory but a nearby store does, all without the customer interacting with a store employee.

In embodiments the customer can be presented with a submenu of items to purchase depending on his store location, and he can fill his cart online without having to physically put it in the cart himself. A store employee can deliver the item at the counter or assist the employee in retrieving the item from the shelf, or alternately can efficiently complete the checkout process online while browsing through the items in a physical store, To improve the in-store experience, audio-visual prompts or cues may be automatically presented to the customer, to self-serve and add products to his cart.

Embodiments link previous user interactions with a business and current location awareness to merge an online and/or virtual shopping cart with physical items at an in-store checkout. Based on the customers previous buying patterns, if it can be known that he buys a particular brand of cereals every week, it can be autosuggested on his online cart, which can be merged with a physical cart post validation from the customer. In addition, additional items may be suggested for cross-sell based on the previous and current buying behavior of products in his cart that can be figured based on the geolocation of cart and products placed in a cart with geolocation sensors attached thereto. Items in the physical cart may be detected based on location sensors attached to product and location sensors attached to the cart, or as explicit input from customer or customer care representative through a computing and/or locating device.

Embodiments link online and/or phone purchases and current location awareness to notify the store proactively of customer proximity to initiate the picking process, e.g. when the customer enters parking lot, the stock room is notified and assembles purchased products for customer pickup. For example, if a customer has purchased a product online, and requested an in-store pickup in the past two days, following that purchase, if the customer is detected in proximity of a physical store, with a certain radius, a pickup process can be initiated, to reduce the queue or wait time for the customer.

Other use cases include, product recommendations in store through a mobile app, product recommendations or personalized campaigns when in proximity of a facility, personalized deals in-store based on physical location in store, in-store ad optimization on digital hoardings based on location of groups of customers in store, public transport or a facility, tracking of viewership and gaze on the ad, automated cart, proactive service calls to customers based on geolocation, for example proactive calls for lost baggage on airport if proximity distance of the baggage location and customer location is high for too long, on-shelf call devices for audio-visual cues to help identify frequently purchased items in a physical store, personalized signage and directions within physical premises, for example giving detailed instructions in a carousal or kiosks to customers at an airport based on their itinerary, eating preferences, wait times, connecting flights, terminal locations, etc.,

Computer Implementation

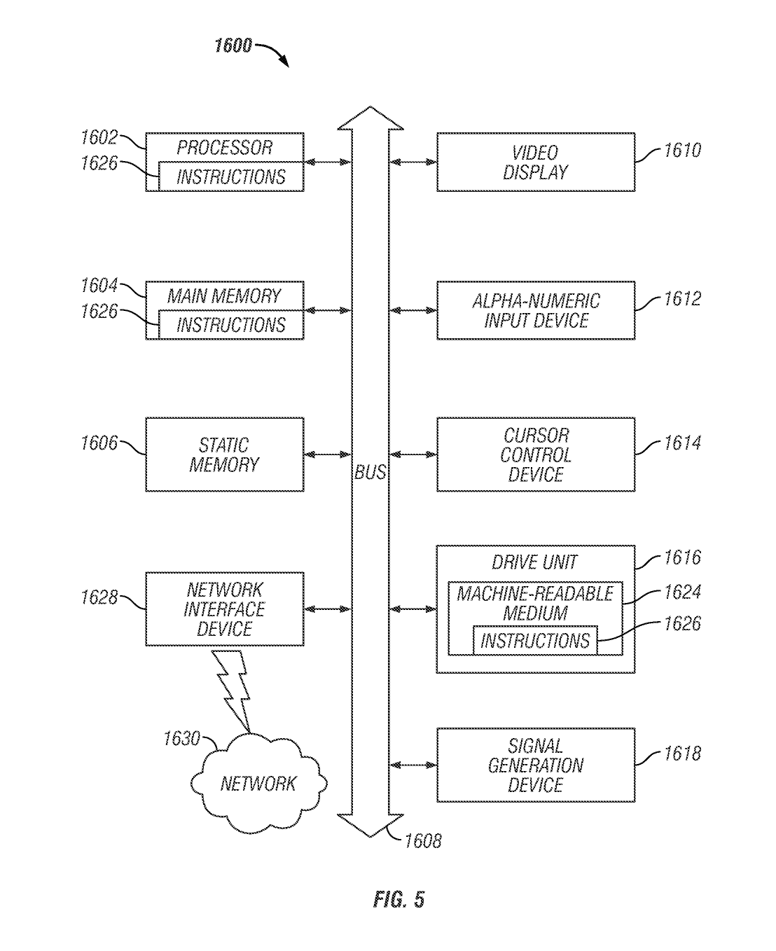

FIG. 5 is a block schematic diagram that depicts a machine in the exemplary form of a computer system 1600 within which a set of instructions for causing the machine to perform any of the herein disclosed methodologies may be executed. In alternative embodiments, the machine may comprise or include a network router, a network switch, a network bridge, personal digital assistant (PDA), a cellular telephone, a Web appliance or any machine capable of executing or transmitting a sequence of instructions that specify actions to be taken.

The computer system 1600 includes a processor 1602, a main memory 1604 and a static memory 1606, which communicate with each other via a bus 1608. The computer system 1600 may further include a display unit 1610, for example, a liquid crystal display (LCD), or a LED screen, or a cathode ray tube (CRT). The computer system 1600 also includes an alphanumeric input device 1612, for example, a keyboard; a cursor control device 1614, for example, a mouse; a disk drive unit 1616, a signal generation device 1618, for example, a speaker, and a network interface device 1628. The disk drive unit 1616 includes a machine-readable medium 1624 on which is stored a set of executable instructions, i.e., software, 1626 embodying any one, or all, of the methodologies described herein below. The software 1626 is also shown to reside, completely or at least partially, within the main memory 1604 and/or within the processor 1602. The software 1626 may further be transmitted or received over a network 1630 by means of a network interface device 1628. In contrast to the system 1600 discussed above, a different embodiment uses logic circuitry instead of computer-executed instructions to implement processing entities. Depending upon the particular requirements of the application in the areas of speed, expense, tooling costs, and the like, this logic may be implemented by constructing an application-specific integrated circuit (ASIC) having thousands of tiny integrated transistors. Such an ASIC may be implemented with CMOS (complementary metal oxide semiconductor), TTL (transistor-transistor logic), VLSI (very large systems integration), or another suitable construction. Other alternatives include a digital signal processing chip (DSP), discrete circuitry (such as resistors, capacitors, diodes, inductors, and transistors), field programmable gate array (FPGA), programmable logic array (PLA), programmable logic device (PLD), and the like.

It is to be understood that embodiments may be used as or to support software programs or software modules executed upon some form of processing core (such as the CPU of a computer) or otherwise implemented or realized upon or within a machine or computer readable medium. A machine-readable medium includes any mechanism for storing or transmitting information in a form readable by a machine, e.g., a computer. For example, a machine readable medium includes read-only memory (ROM); random access memory (RAM); magnetic disk storage media; optical storage media; flash memory devices; electrical, optical, acoustical or other form of propagated signals, for example, carrier waves, infrared signals, digital signals, etc.; or any other type of media suitable for storing or transmitting information.

Although the invention is described herein with reference to the preferred embodiment, one skilled in the art will readily appreciate that other applications may be substituted for those set forth herein without departing from the spirit and scope of the present invention. Accordingly, the invention should only be limited by the Claims included below.

1. A computer implemented method, comprising:
a processor receiving and maintaining awareness of a user's physical location and maintaining said location awareness in real time, as said user moves from location to location;
said processor using said location awareness to discover a nexus between said user's presence within, proximity to, or movement toward one or more physical facilities outside of an explicit user transaction within any of said facilities, wherein said nexus is further discovered by said processor accessing user-related profile information and matching said user-related information to facility-related information, said nexus comprising a coincidence of said user location, said user information, said facility location, and one or more characteristics of said facility that bears a relevant connection with said user-related profile information; and
said processor using said nexus of said user-related information and said facility-related information to create an enhanced user experience within or in connection with said one or more facilities in real time.

2. The method of claim 1, further comprising:
said processor linking online and/or phone purchases and current location awareness of said user to offer related and/or complementary products to said user proactively when said user enters a store for in-store pickup of online purchases; and
said processor linking online and/or phone purchases and current location awareness to notify a store proactively of the user's proximity to initiate a picking process, wherein when said user nears said store a stock room is notified and purchased products are assembled for customer pickup.

3. The method of claim 1, wherein said profile information comprises any of said user's interactions across one or more communication channels with said facility.

4. The method of claim 3, wherein said communications channels comprise any of online, online chat, email, social media, IVR, and call center.

5. The method of claim 1, wherein said profile information comprises any one or more of said user's interactions with said physical facility.

6. The method of claim 1, wherein location awareness is maintained via geo-location of a device within said user's possession.

7. The method of claim 1, said facility comprising any of an aircraft, a vehicle, an airport, a bus, a hospital, a bank, a hotel, a restaurant, a store, a mall, a department store, a service office, an insurance or medical facility, an entertainment venue, a gym, and a movie theater.

8. The method of claim 6, wherein said device comprises any of a wireless device that can be passively interrogated or that passively identifies the user's location.

9. The method of claim 1, said user-related profile information comprising an on-line profile that is associated with the user and that contains information about any of said user's interactions with said facility across one or more said communication channels.

10. The method of claim 1, wherein said one or more facilities are part of a commerce network that provides a service to which any of said facilities and said user subscribe.

11. The method of claim 1, wherein said enhanced user experience comprises presenting sales or other opportunities to said user.

12. The method of claim 1, further comprising;
said processor finding a connection between said user's present location and said user's interactions with said facility across one or more said communication channels; and
said processor identifying stores or other such facilities at or near to said user's location that have a linking connection with said user based upon said user's interactions across one or more communication channels.

13. The method of claim 1, wherein said user is presented with a purchase related opportunity by any of a text message or a sales person who has been alerted of the user's presence at or near the facility.

14. The method of claim 1, further comprising:
said processor making use of a coincidence between said user's presence at a location and a connection between said location and said user's past interaction behavior.

15. The method of claim 1, further comprising:
said processor linking previous user interactions with a business and current location awareness to notify and/or alert said user of a location of products of interest when said user's location coincides with a physical location of said business.

16. The method of claim 15, wherein said products comprise one or more products that said user previously searched for online but did not purchase, or one or more products that a customer is likely to purchase based on any of a previously purchased product, buying behavior or the customer, and buying behavior of other similar customers.

17. The method of claim 1, further comprising:
said processor automatically including relevant items, not currently available in a store, in an incentive offer; and
proactively offering said incentive offer to said user based on said user's preferences.

18. The method of claim 1, further comprising:
said processor linking previous user interactions and/or online and/or phone purchases and current location awareness to notify and/or alert said user proactively when inventory is available in a nearby store.

19. The method of claim 1, further comprising:
said user scanning QR and/or UPC codes in a store to get product information and comparisons, and to purchase online with a mobile device, wherein said product is delivered via a preferred method comprising any of in-store pickup at a current or alternate store or shipping to a preferred address for said user.

20. The method of claim 1, further comprising:
said processor linking previous user interactions with a business and current location awareness to merge an online and/or virtual shopping cart with physical items at an in-store checkout.

21. An apparatus, comprising:
a processor receiving and maintaining awareness of a user's physical location and maintaining said location awareness in real time, as said user moves from location to location;
said processor configured for discovering a nexus between said user's presence within, proximity to, or movement toward one or more physical facilities outside of an explicit user transaction within any of said facilities, wherein said nexus is further discovered by said processor accessing user-related profile information and matching said user-related information to facility-related information, said nexus comprising a coincidence of said user location, said user information, said facility location, and one or more characteristics of said facility that bears a relevant connection with said user-related profile information;
said processor configured for communicating information concerning said user to one or more of said physical facilities at or near to said user's location; and
said processor configured for using a relevant connection of said user-related profile information therein to said user's physical presence at said one or more facilities and one or more characteristics of said one or more facilities to create an enhanced user experience within or in connection with said one or more facilities in real time.

22. The apparatus of claim 21, further comprising:
said processor configured for linking online and/or phone purchases and current location awareness of said user to offer related and/or complementary products to said user proactively when said user enters a store for in-store pickup of online purchases; and
said processor linking online and/or phone purchases and current location awareness to notify a store proactively of the user's proximity to initiate a picking process, wherein when said user nears said store a stock room is notified and purchased products are assembled for customer pickup.
